(19) United States
(12) Patent Application Publication
(10) Pub. No.: US 2002/0046163 A1
(43) Pub. Date: Apr. 18, 2002

(54) Method for controlled exchange of secure information using a personal data safe

(76) Inventor: Alexander Shahidi, Morgan Hill, CA (US)

Correspondence Address: Alex Shahidi, 18090 Crystal Drive, Morgan Hill, CA, 95037, US

(21) Appl. No.: 09/929,088

(22) Filed: Aug. 15, 2001

Related U.S. Application Data
(60) Provisional application No. 60/240,000, filed on Oct. 12, 2000.

(51) Int. Cl. G06F 17/60

(52) U.S. Cl. 705/39; 705/26

(57) ABSTRACT

The invention disclosed involves a method of doing business whereby a user is provided with the capability of conducting transactions in a secure environment such as creating and dispensing information or conducting a purchase and sale transaction within the secure environment.

This application claims the benefit of Provisional Application No. 60240000.

### BACKGROUND OF THE INVENTION

1. Field of the Invention

The present invention relates to a method of conducting the business of gathering, manipulation, storage and selling information and, more particularly, to a method whereby personal information and access is gathered, manipulated and sold while providing user-defined security conditions and privacy.

2. Description of the Known Art

In a free market economy, information concerning the operation of the marketplace has value. Generally, the more detailed and specific the information is, the greater its value. The need for the gathering and selling of consumer information has given rise to a well-established and profitable industry addressing this need using a variety of techniques.

At the same time, a similarly profitable industry has arisen servicing the individual's need to safeguard and keep private the same detailed and specific personal information sought by the aforementioned information vending industry. The ability to keep personal information private is a fundamental component of the well-established First Amendment right to privacy.

Perhaps of even greater value than information about a consumer is direct access to that consumer. One cannot buy what one isn't aware of. Creating consumer demand for a product and servicing that demand is at the very core of a free market economy.

It should be noted that the above interests are inherently in conflict. The ability to keep information private is antithetical to the need to gather and disseminate that very information. The ability to have access to a consumer is antithetical to the consumer's right to be left alone.

The growth of the internet has profoundly affected each of the aforementioned fields, giving rise to increased demand for and capacity to gather information, greater and more sophisticated threats to individual privacy and new means of accessing the consumer both to create and satisfy consumer demand for a product or service. By means of the method of this invention the conflicts noted above may be reconciled to the benefit of all concerned.

Techniques for information gathering range from the innocuous submission of program registration information over the internet to covert monitoring of websites visited by the consumer. The former are purely voluntary while the latter are not only involuntary but may give no notice whatsoever that the information is being collected or communicated to another party. These covert information gathering methods may be combated through the use of secure websites and internet service providers which entirely mask the user's internet activity, allowing unmonitored use of the internet. An example of the sites offering such a masking service is www.zeroknowledge.com. Note that, at the present time, access to a masking service requires the use of an internet service provider approved by the masking service. Additionally, it should be noted that, presently, internet security is essentially an all or nothing proposition. Present internet security systems lack user defined and controlled flexibility. The result is that the only viable scheme of protection extant is still oriented toward the interests of the Internet Service Provider and the masking site. The interests of the consumer are subsumed in those of the service providers. The consumer has little or no influence in the process let alone direct input and control. Additionally, there is no guarantee that those providing the service aren't themselves gathering data on the consumer.

Commercial transactions are routinely conducted on the internet, commonly by the electronic submission of an order form from the buyer to the seller. The order form inherently contains sensitive, and valuable, information such as the name and address of the buyer combined with the fact that they are willing to buy the seller's product. From the information exchanged as part of such transactions valuable customer lists may be compiled. The lists may then be sold for profit by the product seller. The buyer has parted with valuable information while obtaining little or nothing in return for that information. The present systems simply do not provide a free market where a consumer may obtain market price for his information let alone on conditions of the consumer's own choosing. Since the present systems are not consumer driven, they do so in a dynamic and flexible manner.

Goldhaber, et al., 5,855,008 (1998) discloses a method for brokering consumer attention to advertisements for compensation but lacks the security capabilities and flexibility of the virtual person of the present invention. The “private profiles” of Goldhaber 5,855,008 inherently disclose the information within the profile, including the consumer's identity to the company.

Gabber, et al., 5,961,593 (1999) discloses a proxy system enabling anonymous browsing of the internet, in essence the masking device noted above.

Smolen, 5,915,243 (1999) discloses a technique for delivering advertising material to a consumer based on consumer data derived from a questionnaire but it lacks the security and flexibility of the present invention. The consumer has no input into the question asked and the data, including the identity of the consumer, becomes known to the company.

Peckover, 6119,101 (2000) discloses the use of electronic personal agents allowing consumer transactions wherein the identity of the consumer is concealed from the seller but lacks the security features and flexibility of the present invention. The identity of the consumer is not concealed from the company nor are the decision agents wholly user defined.

O'Neil, 5,987,440 (1999) does disclose the use of personal agents to enhance on-line data security but it lacks the flexibility and simplicity of the present invention in that the user lacks full and complete ownership and control over the data of the personal agent and lacks the ability to generate rules for the use of the data based entirely on user determined criteria. Furthermore, it depends for its functionality on the functioning of network communities, requiring their cooperation so that it can perform its intended functions. The requirement of such communities limits, by its very nature, the market for a given datum and the commercial potential of the data provided.

Thus, it may be seen that no method exists which enables a service provider to collect and sell consumer information and access while allowing complete control and ownership of the information itself to remain with the consumer, allowing complete anonymity if desired in commercial and data transactions.

### SUMMARY OF THE PRESENT INVENTION

It is therefore an objective of the present invention to provide a method by which a business may manage the collection and dissemination of consumer information such that the consumer retains ownership and control of the information

It is further an objective of the invention to enable a business to provide a service whereby an individual may selectively collect and control their information for the purpose of maintaining their personal privacy.

It is a further objective of the invention to enable the business to sell the consumer information to third parties, with the consent of the consumer, while maintaining that degree of anonymity required by the consumer and on conditions imposed by the consumer.

It is a further objective of the invention to allow a business to provide a repository for information without the business being able, without authorization, to access the information thus creating a personal data safe.

It is a further objective of the invention to enable the business to sell consumer access to third parties, with the consent of the consumer, while maintaining that degree of anonymity required by the consumer and on conditions imposed by the consumer.

It is a further objective of the invention to enable the business to facilitate the sale and transfer of information between the consumer and a buyer entirely within a rule based, consumer controlled environment.

It is a further objective of the invention to enable the business to facilitate commercial transactions between the consumer and third parties, with the consent of the consumer, while maintaining that degree of anonymity required by the consumer and on conditions imposed by the consumer.

Briefly, practicing the present invention allows the creation of a file containing a body of consumer information comprising a personal data safe under conditions whereby the company is unable to access the data without authorization. The consumer is the true owner of the data, holding both legal and equitable titles thereto. By means of the practice of the invention a true market may be created for information. The market thus formed will be subject to and driven by supply and demand ant the other basic rules of classic economics.

Contained within the personal data safe may be a “virtual person” reflecting the needs, attitudes, habits and interests of the individual consumer, in essence a set of user defined filters.. Although the information resides on servers under the possession and control of the business the business does not have unfettered access to the information. In essence, the relationship created is similar to that of a bank and the renter of a safe deposit box. The bank controls access to the vault but the depositor controls access to the box itself. The depositor has sole control over what is placed in the box and what is removed.

The present invention not only provides an electronic “lock box” but provides, as an additional feature, a “double blind” condition whereby the company may not even have access to the true identity or other data of the consumer without the authorization of the consumer.

Input may be made directly by the consumer or may be done automatically, following instructions and criteria determined by the consumer. For instance, the consumer may directly input his income level or may allow tracking of his internet activity. This may be done by means of conventional techniques outlined above. Information derived from direct input or tracking such as interests and interest levels may be determined and become part of the virtual person.

The virtual person may contain user defined rules of conduct defining how the user, through the virtual person, interacts with the rest of the world and, more specifically, the company. The rules of conduct act in essence like a filter and may be used to dynamically adjust the level of privacy and security of the data.

In practice, a user may choose to disclose no data to the rest of the world and refuse all incoming data. This mode would provide extreme privacy akin to that provided by the masking sites noted above. A user may also decide to make all data within the virtual person available to the company and to accept all inquiries. In this case, security and access would be minimal. By setting the appropriate rules of conduct the user may choose to invoke either no security, absolute security or any intermediate level of security desired.

Although the previous description of the benefits of the present invention have been couched in economic terms, its use extends beyond pecuniary interests to fulfill unsatisfied needs involving simply the need for information security and the guarantee of anonymity. For example, in the medical research field the rules of conduct may be set so as to accept medical data on the user such as genetic information or the user's medical history. Once input, the data may be selectively disclosed according to the rules of conduct established by the user. This would facilitate the collection and accuracy of such data for research purposes as it would remove the possibility of the data being identified to any specific user without express permission.

The invention may also be used as a screening device whereby information subject to various rules and regulations may be examined before transfer. By adjusting the rules of conduct applicable to information contained within a particular personal data safe data may be quarantined pending review of the transfer. In a governmental context, access to state secrets may be limited according to the various security clearances involved. In a private enterprise setting the practice of the invention would increase the effectiveness of corporate vigilance concerning research and development activities or economic data such as sales figures and the like. The fact that a the security features of the invention have been routinely employed may actually demonstrate a company's reasonable efforts to maintain information as a trade secret of the company.

The invention may also be used in the research and development context for the purpose of establishing and maintaining informational “firewalls” where a research and development team must remain isolate from a body of information yet require access to individuals exposed to the information. Thus, groups may be protected from information contamination in reverse engineering situations and may make claims of use of improperly obtained information defeatable.

The above examples are by no means exhaustive. The same model may be followed in the collection of consumer data, attitudinal research, political polling and the like.

In addition to the security aspects of the invention, a fundamental use of the invention would allow company the company to also develop a “bank” of virtual personae containing the aggregate of information made available by the individual consumers. Potential purchasers of information or access may then enter into agreements wherein the company agrees, for a fee, to provide access to the required information or individuals. The company may use the information disclosed to it for analysis allowing output in a great variety of formats and serving many purposes.

Since the business method of the invention allows the consumer to set and control the criteria for use of the information included in the virtual person, the consumer may require that he be compensated for the uses of the information or access. In practice, a seller may approach the company with an offer to pay a set amount for access to a given number of consumers meeting certain criteria. The company may then query the individuals in its bank of virtual personae as to whether they wish to participate in the transaction offering the consumers a fee as an inducement to participate. The fee may be set according to vary with the demographic group of the information provider. The fee may be set so as to vary dynamically with supply and demand to more accurately reflect the market price of the information offered. Those consumers agreeing to participate then view the advertisement or offer under verifiable conditions. Upon verification that the advertisement has been viewed by the consumer payment is deposited to the consumer's account via information contained within the virtual persona. Neither the company nor the access purchaser need be aware of the identity of the consumer unless the nature of the transaction requires such a disclosure.

Similarly, the purchase and sale of goods may be accomplished anonymously using the security advantages of the virtual person. At its simplest the transaction may occur with as a simple buy/sell transaction in which the function of the invention is simply to ensure that no consumer information is gathered or exchanged. In more complex transactions the offer is submitted to the virtual person and communicated to the consumer. The consumer may signal acceptance via the virtual person and the company. Performance on both sides may be accomplished by means of an escrow or the like provided by the company with the company providing verification of receipt of the funds and a means for transshipping the goods. Once again, the contract may be formed and performed under whatever level of security and anonymity selected by the consumer. Note that, in this case, the logistics occur in a manner designed to maintain total anonymity of the customer, if desired. The transmission of the funds and the delivery of the goods are separate and isolated steps with the delivery occurring by means of a third party with no means existing by which the seller may trace the goods to the consumer. Furthermore, the deposit of funds into the escrow may be accomplished by a variety of means including check, cash, bank drafts, services and material in kind and the like thus eliminating the need for a credit card. This method of supplying anonymous logistics achieves the transaction with reasonable rapidity and security but provides absolute assurance of privacy to the consumer.

### IN THE DRAWINGS

It should be noted that the transactions depicted by each figure may be cumulative. For example, the sales transaction of FIG. 3 is a special case of the typical data transaction of FIG. 2. In order to avoid confusion, reiterative elements and steps are selectively not depicted.

FIG. 1 is a flow chart depicting the collection of information into the personal data safe of the invention.

FIG. 2 is a flow chart depicting a typical data transaction of the invention.

FIG. 3 is a flow chart depicting a sales transaction using the method of the invention.

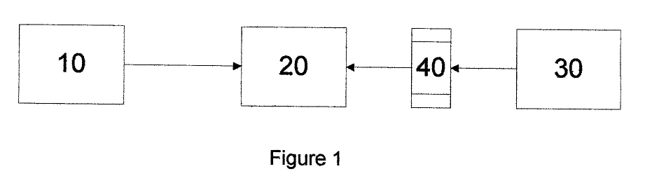

In FIG. 1, Datum A 10 is input into personal data safe 20 by direct means by user. Datum B 30 is input into personal data safe 20 by automatic means, passing through user defined filter 40.

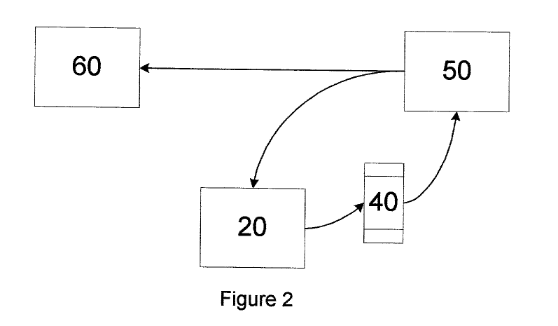

In FIG. 2, A request for information from the company 50 is received by the personal data safe 20. The response is output to the company 50 after passing through user defined filter 40. Payment is then transferred from company 50 to user 60 via instructions contained within personal data safe 20.

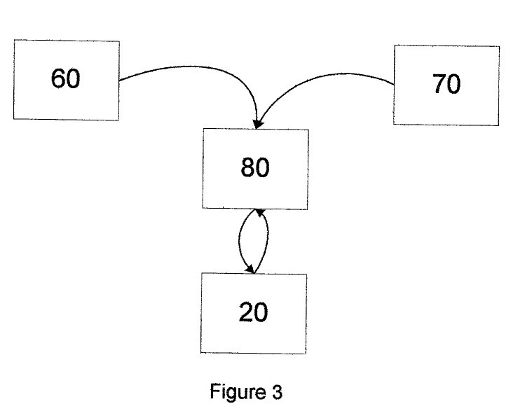

In FIG. 3, upon agreement as to the underlying sales transaction, the seller 70 submits the goods to escrow 80. The user 60 submits the payment to escrow 80. Upon receipt of both the goods and the payment the escrow 80 delivers the goods on instructions contained within the personal data safe 20 and the payment upon instructions from the seller 70.

I claim:

1. A method for using at least one computer, a server and a global communications network to facilitate the transfer of information upon user defined conditions comprising the steps of:
inputting user defined data into the server by means of the computer,
storing said data within a file on the server, said file comprising a data safe,
inputting user defined rules of conduct which, in combination with said user defined data comprises a virtual persona,
communicating a request for data to the user,
releasing data to the requester upon said user defined conditions.

2. The method of claim 1, further comprising the step of restricting access to said data upon user defined conditions.

3. The method of claim 2 further comprising the user defined condition of paying compensation to the user and the step of paying compensation to said user.

4. The method of claim 1 further comprising the step of selling the data to a third party.

5. The method of claim 1 wherein the data consists of medical information of the user.

6. The method of claim 1 wherein the data consists of genetic information of the user.

7. The method of claim 1 wherein the data collected consists of a null set.

8. The method of claim 1 wherein the data released consists of a null set.

9. A method for using at least one computer, a server and a global communications network to facilitate the sale of goods and services upon user defined conditions comprising the steps of:
inputting user defined data into the server by means of the computer,
storing said data within a file on the server, said file comprising a virtual person,
receiving an offer for a sale from a seller,
comparing the terms of said offer with the data within the file to determine the probable interest level of the user,
communicating said offer to the user by means of the file if the probable interest level is sufficient,
receiving an acceptance in the file from the user,
communicating the acceptance of the offer to the seller.

10. The method of claim 9, further comprising the steps of:
communicating the terms of the offer and the acceptance to an escrow,
communicating delivery instructions contained within the file to said escrow,
transferring payment from the user to the escrow,
receiving control of goods into escrow,
transferring payment from the escrow to the seller,
transferring the goods to the user using said delivery instructions.
